(19) United States
(12) Patent Application Publication
(10) Pub. No.: US 2022/0207303 A1
(43) Pub. Date: Jun. 30, 2022

(54) ANNOTATION QUALITY GRADING OF MACHINE LEARNING TRAINING SETS

(71) Applicant: International Business Machines Corporation, Armonk, NY (US)

(72) Inventors: Ella Barkan, Haifa (IL); Dana Levanony, Tel Aviv (IL)

(21) Appl. No.: 17/134,416

(22) Filed: Dec. 27, 2020

(51) Int. Cl. G06K 9/62; G06N 20/00; G06F 40/169

(52) U.S. Cl. CPC G06K 9/6259; G06F 40/169; G06N 20/00; G06K 9/6269

(57) ABSTRACT

Grading the quality of machine learning annotations, by: Obtaining a training set comprising annotated samples that are associated with annotation metadata, wherein the annotation metadata have multiple values that are each unique across the annotation metadata. Training multiple machine learning (ML) models for a classification task, wherein the number of ML models trained equals the number of unique values of the annotation metadata, and wherein the training of each of the ML models is based on the training set, and comprises trimming the training set, to remove those of the annotated samples associated with a different one of the unique values and having a loss that exceeds a threshold. Grading the quality of the annotations per the different unique values, based on relative performance of the trained ML models, respectively. In the grading, the quality is optionally inversely correlated to the performance.

### BACKGROUND

The invention relates to the field of machine learning.

Machine learning (ML) is the study of computer algorithms which automatically improve through experience. It is often viewed as a subset of artificial intelligence (AI). ML algorithms typically construct a mathematical model based on a collection of samples, also termed “training data,” in order to infer predictions or decisions without being specifically programmed to do so.

In the ML field, the term “loss” is often used to denote a numerical value indicative of how inaccurate an ML model's prediction was on a single sample. If the model's prediction is perfect, the loss value is zero; otherwise, the loss value is greater. The objective of training a model is typically defined as finding a set of weights and biases that has as low of a loss value as possible, on average, across all samples. Training is usually conducted over multiple iterative “epochs”—complete passes through the training data.

In supervised (and semi-supervised) ML, samples undergo annotation (also “labeling”), often manual, before being included in the training data. The annotation associated with each sample (its “label”) indicates to the ML algorithm what it should learn from the sample. For example, ML models in the medical imaging field are often trained on the basis of images that have been annotated by radiologists or other experts as “benign,” “malignant,” or other descriptions of clinical features seen in the images. For this reason, an ML model is only as good as the annotations of its training samples; incorrect or inaccurate annotations will lead to a poorly-performing model which is likely to err frequently.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment provides a computer-implemented method which includes: Obtaining a training set including annotated samples that are associated with annotation metadata, wherein the annotation metadata have multiple values that are each unique across the annotation metadata. Training multiple machine learning (ML) models for a classification task, wherein the number of ML models trained equals the number of unique values of the annotation metadata, and wherein the training of each of the ML models is based on the training set, and includes trimming the training set, to remove those of the annotated samples associated with a different one of the unique values and having a loss that exceeds a threshold. Grading the quality of the annotations per the different unique values, based on relative performance of the trained ML models, respectively. In the grading, the quality is optionally inversely correlated to the performance.

Another embodiment provides a system including: (a) at least one hardware processor; and (b) a non-transitory computer-readable storage medium having program code embodied therewith, the program code executable by said at least one hardware processor to: Obtain a training set including annotated samples that are associated with annotation metadata, wherein the annotation metadata have multiple values that are each unique across the annotation metadata. Train multiple machine learning (ML) models for a classification task, wherein the number of ML models trained equals the number of unique values of the annotation metadata, and wherein the training of each of the ML models is based on the training set, and includes trimming the training set, to remove those of the annotated samples associated with a different one of the unique values and having a loss that exceeds a threshold. Grading the quality of the annotations per the different unique values, based on relative performance of the trained ML models, respectively. In the grading, the quality is optionally inversely correlated to the performance.

A further embodiment provides a computer program product including a non-transitory computer-readable storage medium having program code embodied therewith, the program code executable by at least one hardware processor to: Obtain a training set including annotated samples that are associated with annotation metadata, wherein the annotation metadata have multiple values that are each unique across the annotation metadata. Train multiple machine learning (ML) models for a classification task, wherein the number of ML models trained equals the number of unique values of the annotation metadata, and wherein the training of each of the ML models is based on the training set, and includes trimming the training set, to remove those of the annotated samples associated with a different one of the unique values and having a loss that exceeds a threshold. Grading the quality of the annotations per the different unique values, based on relative performance of the trained ML models, respectively. In the grading, the quality is optionally inversely correlated to the performance.

In some embodiments, the relative performance of the trained ML models is determined by validating each of the trained ML models on a validation set including validated annotated samples.

In some embodiments, the classification task is the same as a classification task for which the training set is ultimately intended.

In some embodiments, the training of each of the ML models is performed iteratively, over multiple epochs; the loss is calculated after each of the epochs; and the removal is performed after each of the epochs.

In some embodiments, the different unique values include at least one of: identifiers of different annotators who annotated the annotated samples; different times of the day at which the annotations were made; different days of the week at which the annotations were made; different calendar days of the month at which the annotations were made; and identifiers of different software tools with which the annotations were made.

In some embodiments, the computer-implemented method further includes, or the program code is further executable to: discard from the training set, based on said grading, those of the annotated samples associated with annotations having lower quality grades than other ones of the annotations, to produce a filtered training set; and train a new ML model for the classification task, based on the filtered training set.

In some embodiments, the computer-implemented method further includes, or the program code is further executable to: train a new ML model for the classification task, based on the training set; wherein, in said training of the new ML model, weights are assigned to the annotated samples according to the quality grades associated with their annotations.

In some embodiments of the computer-implemented method, said obtaining, training, and grading are executed by at least one hardware processor.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a block diagram of an exemplary system for quality grading of ML annotations, according to an embodiment.

FIG. 2 is a flowchart of a method for quality grading of ML annotations, according to an embodiment.

### DETAILED DESCRIPTION

Disclosed herein is a technique, embodied in a system, method, and computer program product, for quality grading (also “ranking,” “scoring,” or “rating”) of sample annotations in an ML training set. Advantageously, the grading may be used to discard samples with poorly-graded annotations from the training set, or to assign them with correspondingly-lower weights during training, thereby improving performance of an ML model subsequently trained on that set.

To calculate the quality grade of a certain annotation, the present technique may leverage metadata associated with that annotation. The metadata may include, for example, an identifier (e.g., a name) of the annotator—the person who made the annotation, a time stamp denoting when the annotation was made, an identifier of a software tool used by the annotator to make the annotations, and/or the like. Each of these metadata may encompass a hidden factor affecting annotation quality. For instance, in a large training set annotated by multiple radiologists, some of the annotations may be inaccurate or completely incorrect simply because they were made by an inexperienced radiologist, or because they were made late at night when the annotating radiologists were less coherent. As another example, the software tool used by one or more of the radiologists may be the one at fault—causing the radiologists to make inaccurate or incorrect annotations due to a badly-designed user interface, for instance. However, in the absence of a reliable source of information attesting to the propriety of all such factors, it usually remains an open question whether a given training set hides any poorly-annotated samples that will affect the quality of the resulting ML model.

This becomes an even greater problem when, due to limited resources, a certain training set only includes an annotation by a single expert for each sample, or for a substantial portion of samples. Then, it is not even possible to corroborate annotation accuracy based on multiple sources—different annotators that have had different opinions on how to annotate a certain sample.

The present technique, advantageously, may be able to reliably single out samples whose annotations are of poor quality, purely on the basis of knowledge intrinsic to the training set—the metadata of the annotations. The present technique may act without relying on any corroborating or external knowledge about the samples or their annotations.

To grade the quality of annotations in a particular training set, a user of the present technique may first select the type of metadata according to which the grading is to be conducted. For example, if the user hypothesizes that annotator identity affects annotation quality, she may select the annotator identity metadata type. Alternatively, selection of the type of metadata may be automatic, or the technique may even automatically traverse all types of metadata and generate different sets of quality grades per the different types.

Then, according to the technique, training of multiple ML models for a classification task may commence, where each of these training instances is aimed at testing a hypothesis that a different one of the metadata indicates poor quality of its associated annotations (poor—compared to the annotations associated with all other metadata).

For instance, if the particular training set includes 100 samples each singly annotated by one of two specific persons (e.g., Ella and Dana), the technique may correspondingly train two ML models. These models are trained in the same type of ML task which is ultimately intended for that training set. For example, if the intended task is classification of lesions depicted in medical images as malignant or benign, then the training conducted by the present technique is also performed for that same task, although the resulting models may not be useful for the real classification task, only for annotation quality grading.

When training the model which tests whether Ella's annotations are of the lower quality, the training set may be trimmed, such as after every training epoch, to remove those of Ella's annotated samples whose loss during that epoch exceeded a threshold. Assuming that Ella is indeed the worse annotator, the gradual removal of her high-loss annotated samples, epoch by epoch, will yield a higher-performing (more accurate) model—because it will be eventually trained based mostly (or only, in extreme cases) on Dana's annotated samples.

Conversely, when training the model which tests whether Dana's annotations are of the lower quality, the trimming removes those of Dana's annotated samples whose loss during each epoch exceeded a threshold. Assuming now that Dana is the worse annotator, that gradual removal of her high-loss annotated samples will make this model higher-performing (more accurate) than the other one—because it will be eventually trained based mostly (or only) on Ella's annotated samples.

Performance of the trained models may then be objectively evaluated, such as using a conventional validation process based on validated annotated samples (serving as the “ground truth”), and the quality of the annotations per the different metadata (Ella and Dana) be respectively graded. The per-metadata quality of the annotations is of course inversely correlated to the performance of the respective models: If the first model, which tested the hypothesis that Ella's annotations are of lower quality than Dana's, performed better than the second model—then the first hypothesis has been proven and Dana's annotations are to be assigned with quality grades higher than those of Ella. For example, Dana's annotations may be assigned with a quality grade of “1,” and Ella's with a quality grade of “0,” although grades may of course be on any chosen scale.

More complex scenarios may include, naturally, more than just two metadata and two respective hypotheses that are tested by training two respective models. In such scenarios, the grading may be on any scale that suitably reflects the relative performance of the trained models. For example, the grading may be in the interval [0, 1], which may make it convenient to later weigh annotations by their grades when training the ultimate classification model based on the graded annotations.

This disclosure, although often exemplifying the present technique on the ML task of image classification, directly applies to other types of ML tasks—as those of skill in the art will recognize. For example, ML tasks such as classification, detection, segmentation, Natural Language Processing (NLP), etc., which employ model architectures such as Convolutional Neural Networks (CNNs), Recurrent Neural Networks (RNNs), transformers, etc.—are all explicitly intended herein. Generally, the present technique may apply to any ML task which involves training based on annotated samples of any type—be it imagery, videography, audio, text, or any other digitally-encoded piece of information. In addition, the annotations may be sample-level (“weak”) annotations which are not associated with any smaller, specific portion of the sample, or object-level (“strong”) annotations which are.

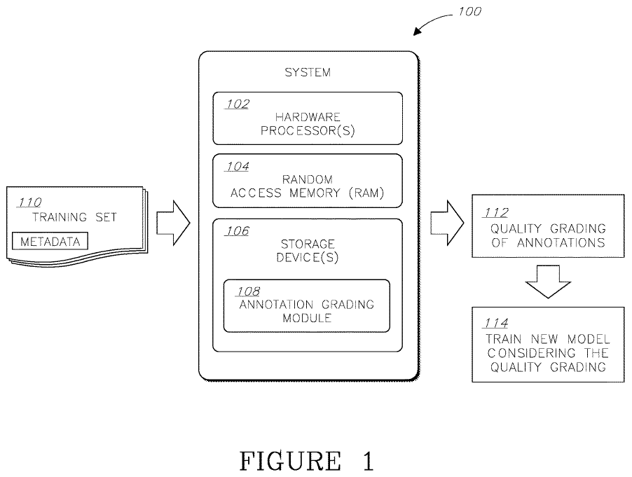

Reference is now made to FIG. 1, which shows a block diagram of an exemplary system 100 for quality grading of annotations, according to an embodiment. System 100 may include one or more hardware processor(s) 102, a random-access memory (RAM) 104, and one or more non-transitory computer-readable storage device(s) 106.

Storage device(s) 106 may have stored thereon program instructions and/or components configured to operate hardware processor(s) 102. The program instructions may include one or more software modules, such as an annotation grading module 108. The software components may include an operating system having various software components and/or drivers for controlling and managing general system tasks (e.g., memory management, storage device control, power management, etc.), and facilitating communication between various hardware and software components.

System 100 may operate by loading instructions of annotation grading module 108 into RAM 104 as they are being executed by processor(s) 102. The instructions of annotation grading module 108 may cause system 100 to receive a training set 110 with metadata, process it, and output a quality grading 112 of annotations of samples included in the training set.

Subsequently, a new ML model may be trained 114 while taking into account and leveraging the quality grades of the annotations. This training may be performed by system 100 itself, or by a different system (not shown) having some or all of the same components (except for a training module that replaces annotation grading module 108).

System 100 as described herein is only an exemplary embodiment of the present invention, and in practice may be implemented in hardware only, software only, or a combination of both hardware and software. System 100 may have more or fewer components and modules than shown, may combine two or more of the components, or may have a different configuration or arrangement of the components. System 100 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 100 may be co-located or distributed, or the system may be configured to run as one or more cloud computing “instances,” “containers,” “virtual machines,” or other types of encapsulated software applications, as known in the art.

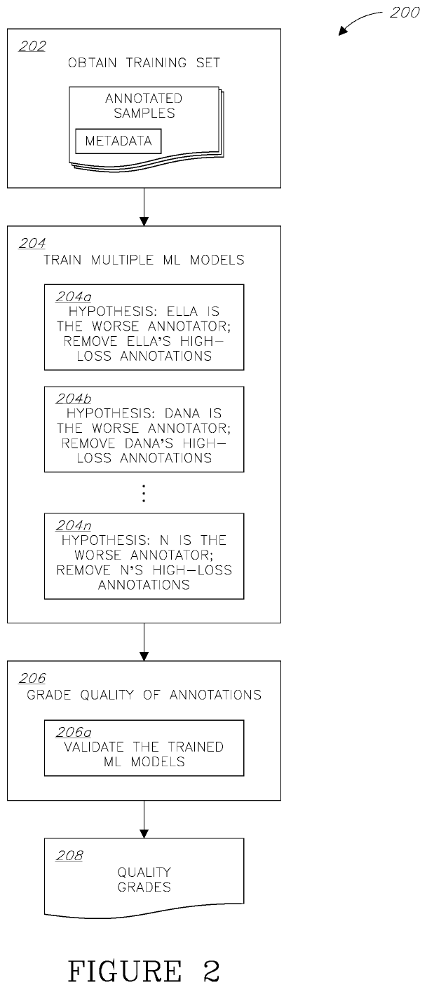

The instructions of annotation grading module 108 are now discussed with reference to the flowchart of FIG. 2, which illustrates a method 200 for quality grading of annotations, in accordance with an embodiment.

Steps of method 200 may either be performed in the order they are presented or in a different order (or even in parallel), as long as the order allows for a necessary input to a certain step to be obtained from an output of an earlier step. In addition, the steps of method 200 are performed automatically (e.g., by system 100 of FIG. 1), unless specifically stated otherwise.

In step 202, a training set including annotated samples and associated annotation metadata may be obtained. Each sample may have at least one annotation associated with it, and each annotation may have at least one annotation metadatum associated with it.

The samples may be digital image files, digital audio files, digital video files, digital text files, and/or the like. The annotations may be embedded in the sample files, or provided as separate digital data associated with the sample files. The annotation metadata, similarly, may be embedded in the sample files, or provided as separate digital data associated with the annotations and/or the sample files.

Each annotation may be one or a few words of text, or any other string or vector of text, numbers, and/or symbols which confers a meaning to a user of method 200. For medical image classification tasks, exemplary annotations include those with values such as “malignant,” “benign,” “normal,” “abnormal,” “irregular,” “tumor,” “stage X,” “stage Y,” “herniated disc,” etc. Those of skill in the art will recognize many other types of classification annotations that are customary in various fields.

Each annotation metadatum may be a value characterizing the associated annotation. For example, annotation metadata may be identifiers (e.g., names, government ID numbers, employee badge number, etc.) of different annotators who annotated the annotated samples. Typically, in a training set containing dozens, hundreds, or a larger number of annotated samples, the samples have been annotated by at least a few persons. Accordingly, it is expected to find at least a few unique values (e.g., “Ella” and “Dana”) across the annotation metadata of the entire training set. Grading the quality of annotations by their annotator may be advantageous, for example, if annotator quality variations are suspected, or if the training set includes only a single annotation (by a single annotator) per sample.

As another example, annotation metadata may be time stamps denoting when (date and/or time) the individual annotations were made, or such metadata may be defined as information derivable from the time stamps, such as just a calendar day of the month (or a range of days), just a time of day (or a range of times of day), just a day of the week (or a range of days of the week), and/or the like. For instance, it may be desired to grade the quality of annotations by a range of times of day which encompasses a night shift of radiologists at a hospital, or a few ranges of times of day encompassing the last few hours of each shift, when radiologists are expected to be less coherent and more prone to annotation mistakes. Similarly, grading may be beneficial according to days of the week, weekdays vs. weekends, or calendar days of the month, if it is suspected that such different days are associated with varying annotation quality.

The user of method 200 may either manually select the type of metadata according to which the grading is to be conducted, such as annotator identity, time of day, annotation software tool, etc. The user may also select multiple such types, which will cause method 200 to execute multiple times in order to separately grade the annotations per each selected type. In another option, selection of the type of metadata may be automatic, such as by automatically parsing the available metadata and either selecting one or more predetermined types, or even automatically executing method 200 multiple times, to traverse all (or some) types of metadata and generate different sets of annotation quality grades per the different types.

In step 204, multiple ML models may be trained for a classification task which is the same task or type of task for which a user intends to ultimately train an ML model. For example, if it is intended to ultimately train a classification model that will be able to infer whether a lesion depicted in a medical image is malignant or benign, then the training of the multiple ML models in step 204 may be generally performed in the same conventional manner the ultimate model will be trained (except for the trimming of the training set discussed further below), for example with a certain CNN architecture. This ensures that the eventual quality grades represent the quality of annotations for the particular task at hand, and not for some other, unrelated task; that is, annotations may have different quality grades respective of different classification tasks, because an inaccuracy of annotation for one task may be less of a problem (or not a problem at all) for another task, and vice versa. Hence, it may be important that the hypotheses testing by method 200 is done based on the same classification task ultimately intended for the training set at hand.

Continuing upon the simplistic example given above of two unique values (“Ella” and “Dana”) existing across the annotation metadata, two ML models, 204a and 204b, may be trained; model 204a may test the hypothesis that Ella is the annotator who produces lower-quality annotations, and model 204b may test the opposite hypothesis, that Dana is in fact the one producing lower-quality annotations.

In scenarios where three or more unique values exist across the annotation metadata, each training instance may test the hypothesis that a different one of the unique values (but not all other unique values) is responsible for, or otherwise associated with, lower-quality annotations. Accordingly, model 204n in the Figure illustrates the n^{th} model which is trained to test the hypothesis that the n^{th} annotator is the worse annotator.

Of course, annotation metadata may include more unique values than what a user of method 200 desires to use for quality grading purposes; for reasons of simplicity, the present discussions refer to “unique values” as those unique values whose analysis is desired and instructed to perform, regardless of whether additional annotation metadata is available, with more unique values.

The training of each of the models, such as models 204a-b, may initially be based on the entire training set, namely—on all the annotated samples regardless of their association with any particular annotation metadata, Ella or Dana in this example.

However, the training of each of these models includes a different mode of trimming the training set: In the case of model 204a, the trimming may include gradual removal of those of the annotated samples which are associated with Ella and have a loss that exceeds a threshold; and in the case of model 204b, the trimming may include gradual removal of those of the annotated samples which are associated with Dana and have a loss that exceeds a threshold.

Since ML training is typically performed iteratively, over multiple epochs, the loss for each annotated sample (that survived a previous removal iteration) may be calculated after each of the epochs, which is also when removal may be performed. Epoch by epoch, more and more annotated samples by Ella or Dana, respective of whether model 204a or 204b is trained, will be trimmed from the training set, and the respective model will be trained based on less and less samples annotated by that person. Of course, one or more of the epochs may not entail removal of any annotated samples at all, if the loss of all annotated samples in that epoch happened to not exceed the threshold.

The threshold used for determining which annotated samples are to be removed may be a predetermined threshold, e.g., a rule by which a loss value over X destines the annotated sample to removal, or a dynamic threshold, e.g., a rule by which a loss value exceeding a certain statistical measure in relation to other loss values of the same epoch destines the annotated sample to removal. In a dynamic threshold, a statistical measure, such as mean, mode, or median loss value, may be calculated following each epoch, and any annotated samples whose loss values are greater by a certain percentage or a certain standard deviation from that statistical measure may be removed. These are merely examples, and a dynamic threshold may in practice be based on any statistical calculation designed to detect outlier, high, loss values.

Next, in step 206, quality of the annotations may be graded per each of Ella and Dana, namely—per the different unique values in the annotation metadata. This grading may be based on relative performance of the trained models 204a and 204b, respectively; Ella's annotation grading will be based on performance of the trained model 204a, and Dana's annotation grading will be based on performance of the trained model 204b.

The grading may be determined in inverse (also “negative’) correlation to the performance; annotations associated with a certain unique value (e.g., Dana) will be graded higher if the model (e.g., 204b) in which their associated annotated samples were removed turns out to perform weakly, and vice versa.

Assume, for the sake of example, that many of Ella's annotated samples were removed when training model 204a, but that a much lower number of Dana's annotated samples were removed when training model 204b. Typically, in such a scenario, model 204a will perform stronger than model 204b, because the former was trained on more accurately-annotated samples than the latter.

The quality grades, which may also be referred to as quality “scores,” may be on any scale that suitably reflects (in the inverse, of course) the relative performance of the trained models. For example, the quality grades may be in the interval [0, 1], or in any other interval or grading scale.

To determine the relative performance of the trained models, they may each undergo validation 206a based on a validation set which includes validated annotated samples, as done conventionally to validate ML models. One or more performance metrics may be calculated following such validation, such as accuracy, precision, recall, confusion matrix, F1 score, and/or any other suitable metric. The performance of each trained model, and accordingly the relative performance of all trained models, may be determined according to one such metric or a combination of multiple such metrics, based on user preference.

Lastly, in step 208, the quality grades of the annotations may be output, such as by presenting them to a user, embedding each quality grade in the digital file of its annotated sample, or adding the quality grades of the annotations to a digital file which already stores the annotations and/or the annotation metadata.

The quality grades of the annotations may be later utilized when conducting the ‘real’ training of an ML model for the task at hand, such as when training a classifier to infer whether a lesion depicted in a medical image is benign or malignant. The quality grades may improve performance of the eventual model, because they may prevent its training on the basis of low-quality (inaccurate or incorrect) annotations.

In one option, the training set may be filtered in accordance with the quality grades, discarding from it those of the annotated samples which are associated with annotations having lower quality grades than others; for example, annotated samples associated with bottom-k graded annotations may be discarded, where k is either a percentage (e.g., 5%, 10%, 20%, 30%, 40%, 50% or more) or an absolute number. Then, a new ML model may be trained for the classification task, based on the filtered training set. This new ML model is likely to perform better than a model that would have been trained on the entirety of the training set.

In another option, the training of a new ML model may be based on the entire training set, but while assigning different weights to different annotated samples according to of their associated quality grades. This way, the new ML model may still partly benefit from the information contained in less than perfectly-graded annotated samples, because it will learn, albeit to a lesser extent, from annotated samples whose annotations are inaccurate but not entirely incorrect.

The present invention may be a computer system, a computer-implemented method, and/or a computer program product. The computer program product may include a computer readable storage medium (or media) having computer readable program instructions thereon for causing a hardware processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a hardware processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A computer-implemented method comprising:
obtaining a training set comprising annotated samples that are associated with annotation metadata, wherein the annotation metadata have multiple values that are each unique across the annotation metadata;
training multiple machine learning (ML) models for a classification task, wherein the number of ML models trained equals the number of unique values of the annotation metadata, and wherein said training of each of the ML models:
is based on the training set, and
comprises trimming the training set, to remove those of the annotated samples associated with a different one of the unique values and having a loss that exceeds a threshold; and
grading quality of the annotations per the different unique values, based on relative performance of the trained ML models, respectively,
wherein, in said grading, the quality is inversely correlated to the performance.

2. The computer-implemented method of claim 1, wherein the relative performance of the trained ML models is determined by validating each of the trained ML models on a validation set comprising validated annotated samples.

3. The computer-implemented method of claim 1, wherein the classification task is the same as a classification task for which the training set is ultimately intended.

4. The computer-implemented method of claim 1, wherein:
the training of each of the ML models is performed iteratively, over multiple epochs;
the loss is calculated after each of the epochs; and
the removal is performed after each of the epochs.

5. The computer-implemented method of claim 1, wherein the different unique values comprise at least one of:
identifiers of different annotators who annotated the annotated samples;
different times of the day at which the annotations were made;
different days of the week at which the annotations were made;
different calendar days of the month at which the annotations were made; and
identifiers of different software tools with which the annotations were made.

6. The computer-implemented method of claim 1, further comprising:
discarding from the training set, based on said grading, those of the annotated samples associated with annotations having lower quality grades than other ones of the annotations, to produce a filtered training set; and
training a new ML model for the classification task, based on the filtered training set.

7. The computer-implemented method of claim 1, further comprising:
training a new ML model for the classification task, based on the training set;
wherein, in said training of the new ML model, weights are assigned to the annotated samples according to the quality grades associated with their annotations.

8. The computer-implemented method of claim 1, wherein said obtaining, training, and grading are executed by at least one hardware processor of the computer in which the method is implemented.

9. A system comprising:
(a) at least one hardware processor; and
(b) a non-transitory computer-readable storage medium having program code embodied therewith, the program code executable by said at least one hardware processor to:
obtain a training set comprising annotated samples that are associated with annotation metadata, wherein the annotation metadata have multiple values that are each unique across the annotation metadata;
train multiple machine learning (ML) models for a classification task, wherein the number of ML models trained equals the number of unique values of the annotation metadata, and wherein the training of each of the ML models:
is based on the training set, and
comprises trimming the training set, to remove those of the annotated samples associated with a different one of the unique values and having a loss that exceeds a threshold; and
grading quality of the annotations per the different unique values, based on relative performance of the trained ML models, respectively,
wherein, in the grading, the quality is inversely correlated to the performance.

10. The system of claim 9, wherein the relative performance of the trained ML models is determined by validating each of the trained ML models on a validation set comprising validated annotated samples.

11. The system of claim 9, wherein the classification task is the same as a classification task for which the training set is ultimately intended.

12. The system of claim 9, wherein:
the training of each of the ML models is performed iteratively, over multiple epochs;
the loss is calculated after each of the epochs; and
the removal is performed after each of the epochs.

13. The system of claim 9, wherein the different unique values comprise at least one of:
identifiers of different annotators who annotated the annotated samples;
different times of the day at which the annotations were made;
different days of the week at which the annotations were made;
different calendar days of the month at which the annotations were made; and
identifiers of different software tools with which the annotations were made.

14. The system of claim 9, wherein the program code is further executable to:
discard from the training set, based on the grading, those of the annotated samples associated with annotations having lower quality grades than other ones of the annotations, to produce a filtered training set; and
train a new ML model for the classification task, based on the filtered training set.

15. The system of claim 9, wherein the program code is further executable to:
train a new ML model for the classification task, based on the training set;
wherein, in the training of the new ML model, weights are assigned to the annotated samples according to the quality grades associated with their annotations.

16. A computer program product comprising a non-transitory computer-readable storage medium having program code embodied therewith, the program code executable by at least one hardware processor to:
obtain a training set comprising annotated samples that are associated with annotation metadata, wherein the annotation metadata have multiple values that are each unique across the annotation metadata;
train multiple machine learning (ML) models for a classification task, wherein the number of ML models trained equals the number of unique values of the annotation metadata, and wherein the training of each of the ML models:
is based on the training set, and
comprises trimming the training set, to remove those of the annotated samples associated with a different one of the unique values and having a loss that exceeds a threshold; and
grading quality of the annotations per the different unique values, based on relative performance of the trained ML models, respectively,
wherein, in the grading, the quality is inversely correlated to the performance.

17. The computer program product of claim 16, wherein the classification task is the same as a classification task for which the training set is ultimately intended.

18. The computer program product of claim 16, wherein:
the training of each of the ML models is performed iteratively, over multiple epochs;
the loss is calculated after each of the epochs; and
the removal is performed after each of the epochs.

19. The computer program product of claim 16, wherein the different unique values comprise at least one of:
identifiers of different annotators who annotated the annotated samples;
different times of the day at which the annotations were made;
different days of the week at which the annotations were made;
different calendar days of the month at which the annotations were made; and
identifiers of different software tools with which the annotations were made.

20. The computer program product of claim 16, wherein the program code is further executable to:
(a) discard from the training set, based on the grading, those of the annotated samples associated with annotations having lower quality grades than other ones of the annotations, to produce a filtered training set, and
train a new ML model for the classification task, based on the filtered training set; or
(b) train a new ML model for the classification task, based on the training set, and wherein, in the training of the new ML model, weights are assigned to the annotated samples according to the quality grades associated with their annotations.
